(19) United States
(12) Patent Application Publication
(10) Pub. No.: US 2018/0075535 A1
(43) Pub. Date: Mar. 15, 2018

(54) SYSTEM FOR VISUALIZATION OF RISK ALLOCATION

(71) Applicant: Carlos Alvarenga, Bethesda, MD (US)

(72) Inventor: Carlos Alvarenga, Bethesda, MD (US)

(21) Appl. No.: 15/702,326

(22) Filed: Sep. 12, 2017

Related U.S. Application Data
(60) Provisional application No. 62/393,206, filed on Sep. 12, 2016.

(51) Int. Cl. G06Q 40/06; G06Q 40/08; G06F 3/0481; G06T 19/00

(52) U.S. Cl. CPC G06Q 40/06; G06T 19/003; G06F 3/04815; G06Q 40/08

(57) ABSTRACT

A risk management system includes a central processing unit and a display device connected to the central processing unit. The display device is configured to display a risk topology including a three-dimensional visualization of a risk portfolio for predetermined period of time. The three-dimensional visualization shows an allocation of mitigation investments for a plurality of designated asset classes.

### PRIORITY CLAIM

The present disclosure is a Non-Provisional patent application claiming the benefit of and priority to U.S. Provisional Patent Application No. 62/393,206 filed on Sep. 12, 2016, which is incorporated by reference herein in its entirety.

### BACKGROUND OF THE INVENTION

The present disclosure relates to systems and methods for visualizing and assessing risk positions for an organization. Organizations face operational risk on several levels. Organizations need tools to assist their managers and decision-makers to assess risk and determine where it should spend it limited resources in order to minimize the operational risk to the company.

In known systems and methods, risk is assessed in a simple financial sense that does not take a holistic or comprehensive view of financial and economic costs of risk. These known systems and methods, therefore, are limited and do not provide adequate data or tools to assist the decision-makers in allocating resources to risk mitigation investments.

Another limitation of known systems and methods is that they lack a useful tool for visualizing a risk position of the company such that reallocation of mitigation investments can be contemplated and executed by an organization.

Still another limitation of known systems and methods is that they do not map costs of risk or mitigation investments against various classes of assets in an organization. Without such additional functionality and visualization tools, decision-makers cannot effectively allocate resources to the proper class of assets to properly address the operational risk of the organization.

### SUMMARY OF THE INVENTION

In one aspect of the present disclosure, a risk management system is described. The risk management system includes a central processing unit and a display device wherein the display device is configured to display a risk topology including a three-dimensional visualization of a risk portfolio for a predetermined period of time.

In another aspect of the present disclosure, the displayed risk portfolio includes an allocation of mitigation investments for one or more designated asset classes.

In still another aspect of the present disclosure, the three-dimensional visualization of the risk portfolio displays the cost of risk for a plurality of designated asset classes.

The present disclosure also describes a method of producing a risk topology. The method includes the steps of modeling costs associated with one or more operational risks related to an organization, modeling investments to mitigate the risks and modeling the risk portfolio to display the risk topology.

### BRIEF DESCRIPTION OF THE DRAWING

Details of the present disclosure, including non-limiting benefits and advantages, will become more readily apparent to those of ordinary skill in the relevant art after reviewing the following detailed description and accompanying drawings, wherein:

FIG. 1 depicts a block diagram of a risk management system suitable for use with the methods and systems consistent with the present disclosure;

FIG. 2 shows a more detailed depiction of one embodiment of a risk management system;

FIG. 3 shows a more detailed depiction of the system of FIG. 1;

FIG. 4 shows another depiction of a system of the present disclosure;

FIG. 5 depicts an illustration of the operation of a risk management system of the present disclosure;

FIG. 6 depicts an illustration of a sub-operation of the operation depicted in FIG. 5;

FIG. 7 depicts an illustration of a sub-operation of the operation depicted in FIG. 5;

FIG. 8 depicts an illustration of a sub-operation of the operation depicted in FIG. 5;

FIG. 9 depicts an illustrative example of the sub-operation depicted in FIG. 6;

FIG. 10 depicts an illustrative example of the sub-operation depicted in FIG. 7; and

FIG. 11 depicts an illustrative example of visualization output of system of the present disclosure.

### DETAILED DESCRIPTION OF THE INVENTION

While various embodiments of the present disclosure are described herein, it will be apparent to those of skill in the art that many more embodiments and implementations are possible that are within the scope of this invention. Accordingly, the present disclosure is not to be restricted except in light of the attached claims and their equivalents.

Described herein is a system for analyzing, allocating and visualizing a risk portfolio of an organization for the purposes of effectively managing risk. Some advantages of the system described includes the ability to provide an understanding of both Return on Investment (ROI) and Internal Rate of Return (IRR). The system further provides the advantage of risk management optionality, that is, the ability to visualize and assess alternatives and see the effects of changes to risk management alternatives in an organizations risk portfolio. For example, the system of the present disclosure can be an effective tool for pricing and assisting an organization in choosing insurance options to mitigate risk. Still other advantages and purposes of the system of the present disclosure are described and will be apparent from the following description.

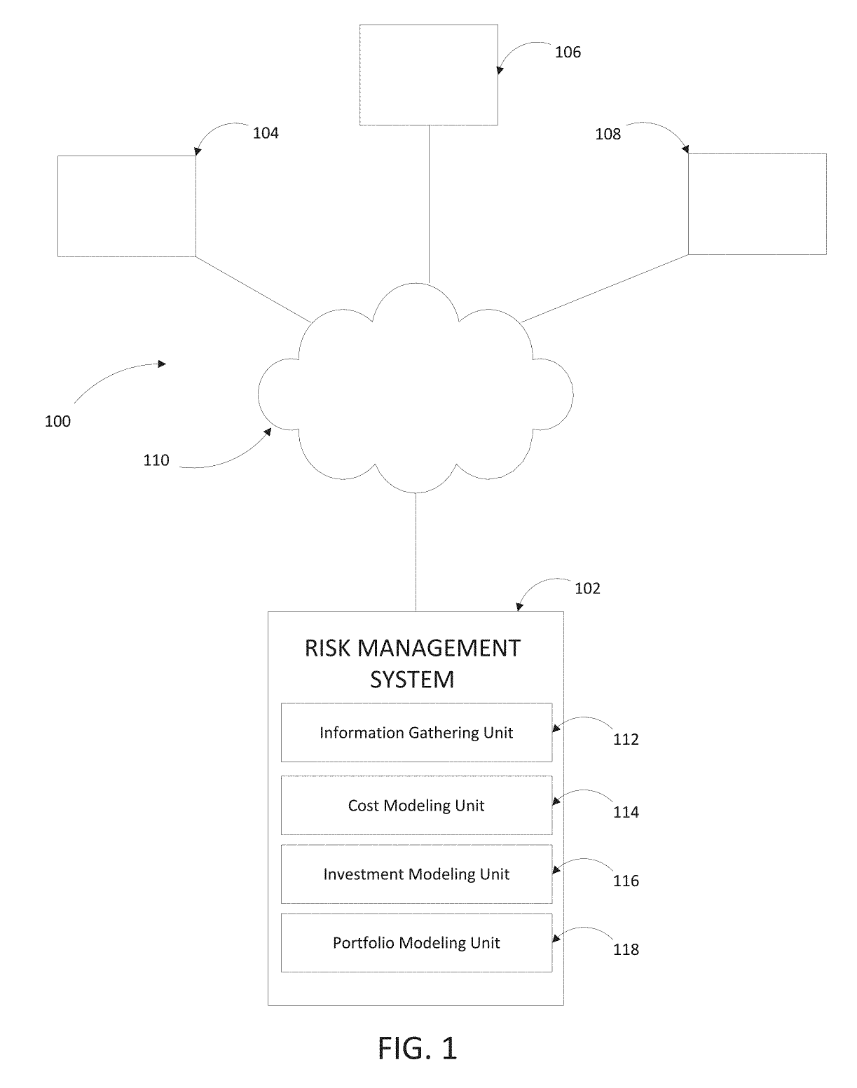

FIG. 1 depicts a block diagram of a risk management system 100 suitable for use with the methods and systems consistent with the present disclosure. The risk management system 100 comprises a plurality of computers 102, 104, 106 and 108 connected via a network 110. The network 110 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104 and 106 shown in FIG. 1 is connected to the network 110 via a suitable communication link, such as a dedicated communication line or a wireless communication link.

In an illustrative example, computer 102 serves as a risk management system that includes an information gathering unit 112, a cost modeling unit 114, an investment modelling unit 116, and a portfolio modeling unit 118. The number of computers and the network configuration shown in FIG. 1 are merely an illustrative example. One having skill in the art will appreciate that the risk management system 100 may include a different number of computers and networks. For example, computer 102 may include the information gathering unit 112 as well as one or more of the cost modeling unit 114 and portfolio modeling unit 118. Further, the investment modelling unit 116 may reside on a different computer than computer 102.

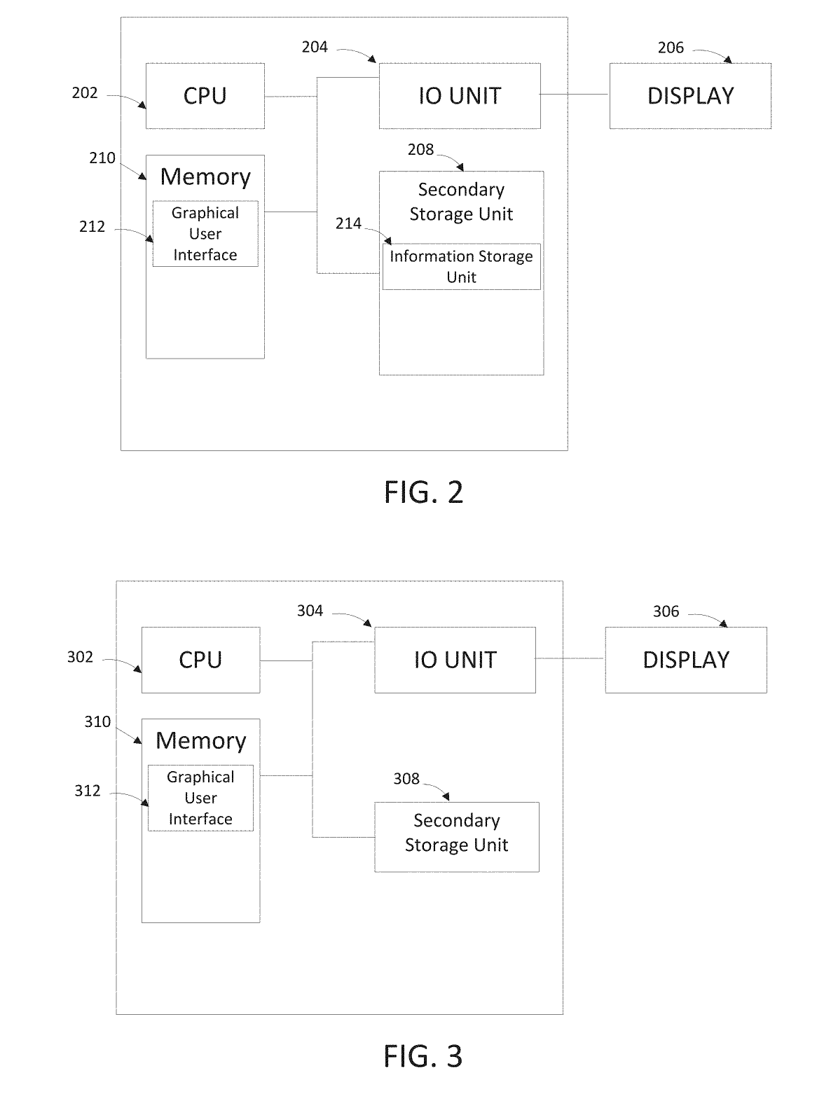

FIG. 2 shows a more detailed depiction of the computer 102. The computer 102 comprises a central processing unit (CPU) 202, an input output (IO) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 which is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present disclosure, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (I/O) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a Graphical User Interface (“GUI”) 312 which is used to gather information from a user via the display device 306 and I/O unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present disclosure, the GUI 312 is displayed using commercially available hypertext markup language (“HTML”) viewing software such as, but not limited to, Microsoft Internet Explorer, Google Chrome or any other commercially available HTML viewing software.

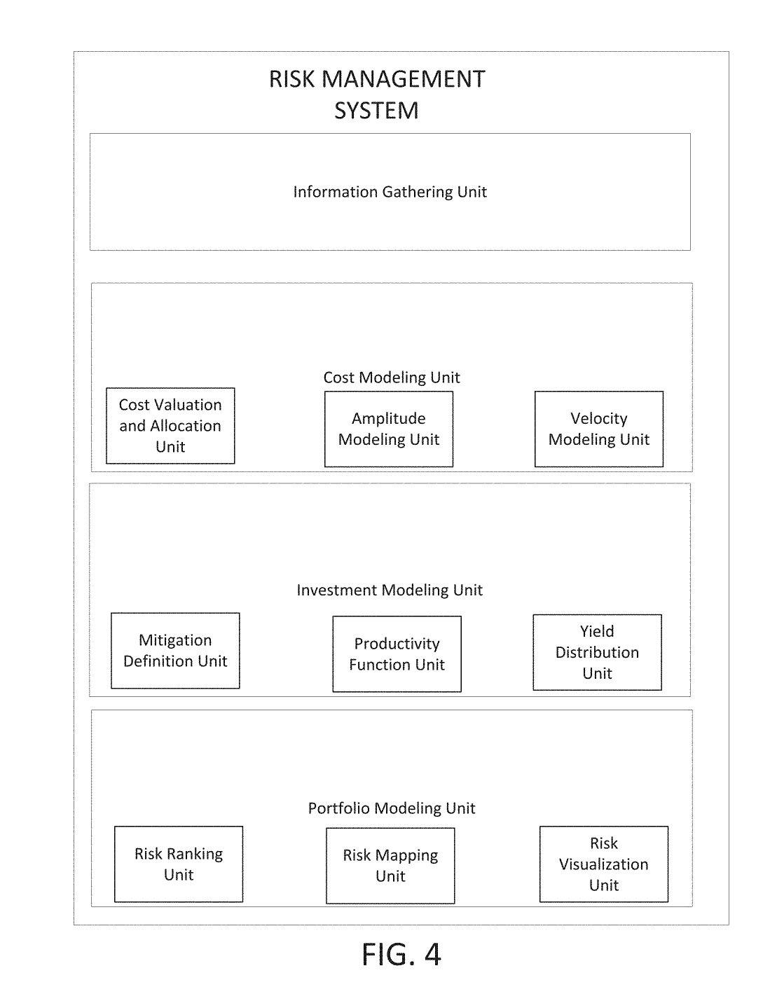

FIG. 4 depicts an illustrative example of risk management system 100. In this example, further components of the units of risk management system 100 are shown. Cost modeling unit 114 may include cost valuation and allocation unit 402, amplitude modeling unit 404 and velocity modeling unit 406. Investment modeling unit 116 may include mitigation definition unit 408, productivity function unit 410 and yield distribution unit 412. Portfolio modeling unit 118 may include risk ranking unit 414, risk mapping unit 416 and risk visualization unit 418.

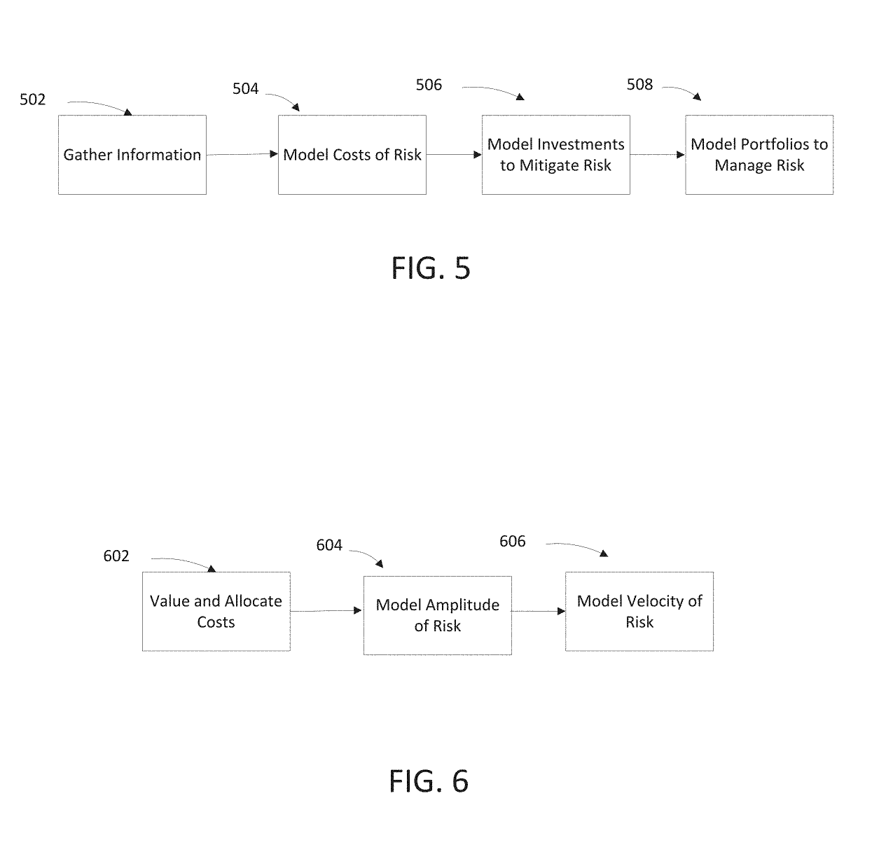

An illustration of the operation of risk management system 100 is shown in FIG. 5. At step 502, information gathering unit 112 in the risk management system 102 collects information necessary for the operation of the system. Information gathering unit 112 can collect information that is input through one or more user interfaces, by connecting to network 110 and searching various sources or repositories of information and data, or by connecting to one or more computers 104, 106 or 108 on which information and data may be stored. The information gathered by information gathering unit 112 may include price information, cost information, historical data, market data or any other data that can be used as will be explained. The information collected by information gathering unit 112 can be stored permanently, or via transitory means, by risk management system 102, such as via memory 210 or information storage unit 214.

At step 504, the costs associated with risk related to the operation of an organization is evaluated. At step 504, the following question is answered: What is risk costing me today in both financial and economic terms? FIG. 6 illustrates further detail regarding possible sub-steps that may be involved with the performance of step 504. As illustrated, the first sub-step is sub-step 602 in which the costs of operational risk are valued and allocated. At this sub-step all financial and economic risks are assessed. For example, the variation of costs of raw materials, labor or other inputs related to the production of specific goods could be assessed at this sub-step. Historical price variations, possible changes in governmental policy or increased energy costs could all be costs of risk that are assessed at this sub-step.

The next sub-step that may be performed as part of step 504 is sub-step 604: Model Amplitude of Risk. At this sub-step the risk adjusted present cost of a future distribution is assessed. The volatility of the cost of risk is modeled in order to better predict and model possible variations in cost of risk. Finally, sub-step 606 may also be performed in connection with step 504. At Sub-step 606 the velocity or slope of the cost of risk function is modeled in order to determine the trajectory of cost curve developed during the valuing and modeling sub-steps previously described. At the conclusion of sub-steps 602 through 606, a cost of risk function is developed. An illustration of a cost of risk function is shown in FIG. 9.

Referring now back to FIG. 5, the next step that may be performed in the example shown is modeling investments to mitigate risk at step 506. At this step, the risks identified at step 504 are considered and the various alternatives to mitigate the identified risk and the costs or investments associated with such mitigation alternatives are modeled. At this step the following question is answered: What is the right level of investment against any specific risk?

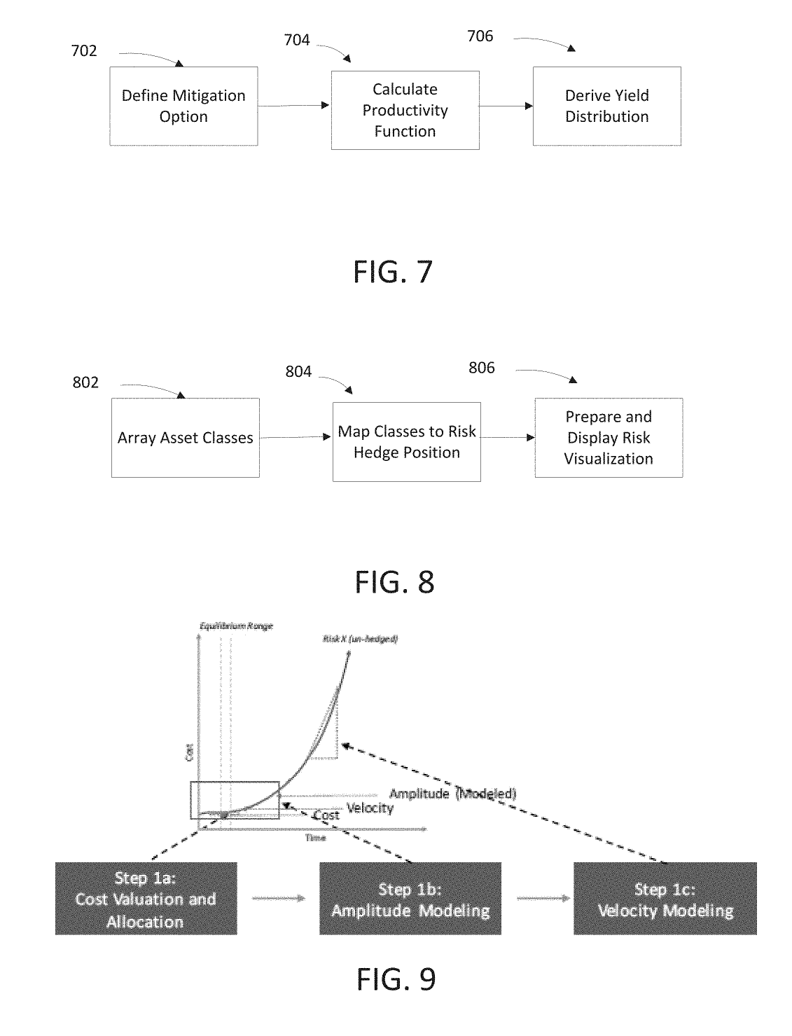

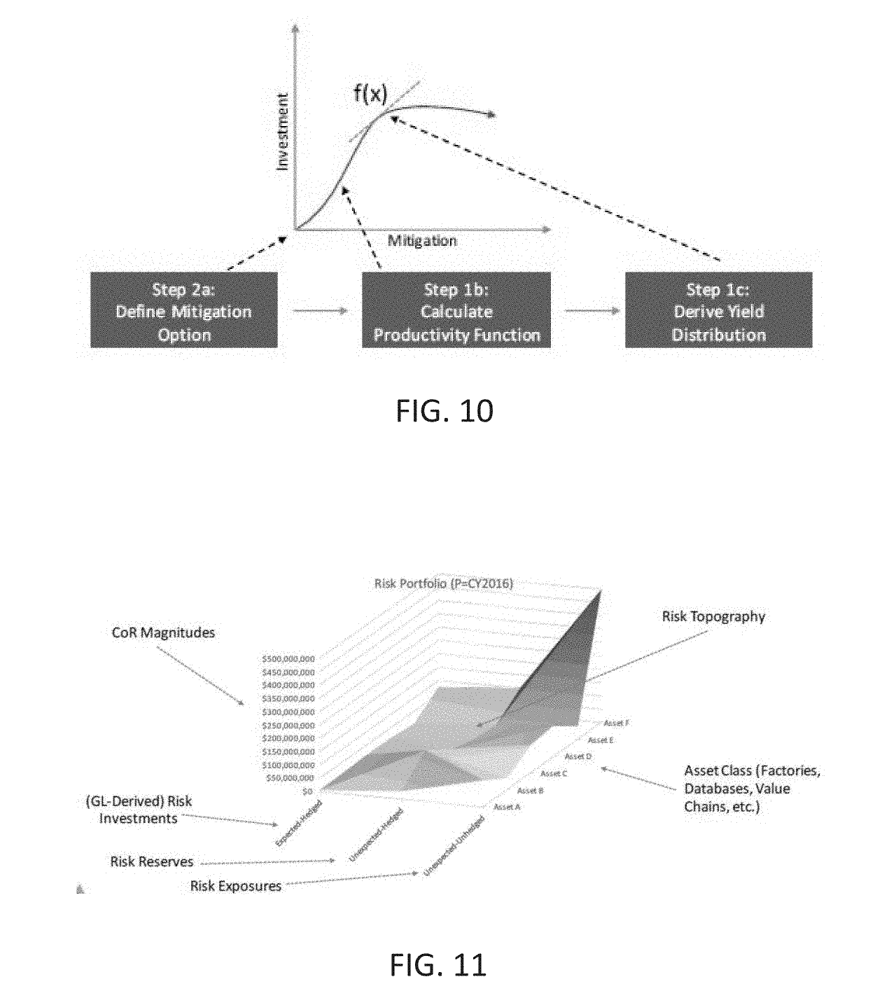

FIG. 7 illustrates possible sub-steps associated with the modeling investments step 506. The first sub-step is shown at sub-step 702. At this step the various alternatives for mitigating risk are defined. The definition phase includes the goal of describing the characteristics of any given mitigation option. The various characteristics that are defined may include the cost of the option, the complexity of the option, the duration of the option or any other relevant characteristic. Once the mitigation options are defined, sub-step 704 may be performed in which the productivity function of each mitigation option is calculated. At step 704 the relationship between a unit of cost for the mitigation option is determined for each unit of risk cost along a risk trajectory. Next, sub-step 706 may be performed. At sub-step 706, a yield distribution of the mitigation option is determined. With the yield distribution, the optimal investment threshold for a given mitigation strategy can be determined. As shown in FIG. 10, one way of evaluating the optimal investment threshold is to determine the location on the derived yield distribution where a unit of investment in a mitigation option results in less than a unit of risk cost. At this point, the marginal investments do not return more than what is invested. One alternate way of analyzing mitigation options under step 506 is to use the Gordon-Loeb model for investment analysis. Other methods of determining an optimal investment can also be used.

Referring back to FIG. 5, the sample operation of risk management system 100 continues at step 508. At step 508, the portfolios to manage risk are modeled. In this step, the costs of risk and the possible investments to mitigate the risk are allocated in various ways to understand the risk management allocations that are contemplated by an organization. The complexity of this step is variable depending on the need of the organization at the time. Since the inputs to this step, as previously discussed, change over time, this resultant modelling will change over time as well. At this step the allocation and risk positions of an organization can be modeled and displayed via a visualization tool such that possible changes to risk management allocations can be easily shown. The visualization tool can be used by managers of an organization to determine if changes to a current allocation should be made or to raise awareness of exposure to risk with respect to various asset classes in the organization.

FIG. 8 depicts example sub-steps that may be performed at step 508. The example sub-steps include array asset classes at sub-step 802, mapping classes to risk hedge positions at sub-step 804 and preparing and displaying risk visualization at sub-step 806. At sub-step 802, all assets of an organization are categorized and any investments to mitigate risks are allocated accordingly. At sub-step 804, the classes (or categories) of assets are mapped to a risk hedging position. For example, some risks are hedged and some are not hedged. The likelihood of such risk occurring is also assessed and mapped against the classes of assets and to the risk hedge position. In one example, the mapping previously described is performed for a given time period. In this manner, a snapshot of the risk position of an organization for a time period can be obtained.

At sub-step 806, a risk visualization is prepared and displayed. When the allocation and mapping of the investments and risks positions has been completed, a visualization of the risk position is useful for a manager or other organization decision-maker to assess current risk levels and determine if changes are advisable. As shown in FIG. 11, one example risk visualization demonstrates a visualization tool displaying a risk position. In this example, a three-dimensional graphical tool shows a risk topography created using the previously described method and system. In this example, the three dimensions shown on risk topography 1100 include cost of risk, risk exposure and asset class. Risk topography 1100, in this example, shows a risk position for a calendar year. In this example, the risk exposure axis includes three classifications, namely expected-hedged, unexpected-hedged and unexpected-unhedged. The expected-hedged classification includes those operational risks for which an organization has made an investment to hedge a risk that is likely or expected to occur. The unexpected-hedged classification includes those operational risks for which an investment has been made but the risk is unlikely to occur. This classification can also be called the risk reserves. The last classification shown in the example is unexpected-unhedged. This classification shows risk exposures for which no mitigation investments have been made. These classifications are mapped against various asset classes that can be operational assets such as factories, databases, or other value chains.

As can be seen in this example, risk topography 1100 can be useful to assist decision makers in identifying a risk position of an organization and making changes when necessary or desirable. For example, as shown in FIG. 11, the risk exposure associated with Asset F appears to have a significant cost of risk. The organization can explore the possibility of shifting monies from the risk reserves (i.e., unexpected-hedged classification) to Asset F to reduce this risk exposure.

FIG. 11 shows one example risk visualization that can be created using the system and methods of the present disclosure. Other variables or other data and related mapping and allocations can also be displayed using risk mapping unit 416 or risk visualization unit 418. Other types of graphical outputs that include other topographies that include other classifications and data can also be used.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A risk management system comprising:
a central processing unit; and
a display device connected to the central processing device;
wherein the display device is configured to display a risk topology including a three-dimensional visualization of a risk portfolio for a predetermined period of time.

2. The risk management system of claim 1 wherein the three-dimensional visualization of the risk portfolio displays an allocation of mitigation investments for a plurality of designated asset classes.

3. The risk management system of claim 1 wherein the three dimensional visualization of the risk portfolio displays a cost of risk for a plurality of designated asset classes.

4. A method of producing a risk topology comprising:
modeling costs associated with a plurality of operational risks related to a organization;
modeling investments to mitigate risks associated with at least one operational risk of the the plurality operational risks; and
modeling a risk portfolio in order to manage the plurality of operational risks.

5. The method of claim 4 wherein the step of modeling costs associated with a plurality of operational risks further comprises:
valuing and allocating costs of the plurality of operational risks;
modeling a amplitude of the plurality of operational risks; and
modeling a velocity of the plurality of operational risks.

6. The method of claim 4 wherein the step of modeling investments to mitigate risks further comprises:
defining one or more mitigation options;
calculating a productivity function for the one or more mitigation options; and
deriving a yield distribution for the one or more mitigation options.

7. The method of claim 4 wherein the step of modeling a risk portfolio further comprises:
producing an array of asset classes;
mapping the array of asset classes to risk hedge positions; and
preparing and displaying a risk visualization.

8. The method of claim 7 wherein the risk visualization comprises a three-dimensional risk topology for a predetermined period of time.

9. A risk management system comprising a central processing unit, memory, an input output unit and a display device configured to perform the steps of claim 4.

10. Non-transitory machine-readable medium containing executable instructions that, when executed by at least one processor, cause the at least one processor to:
model costs associated with a plurality of operational risks related to a organization;
model investments to mitigate risks associated with at least one operational risk of the plurality operational risks; and
model a risk portfolio in order to manage the plurality of operational risks.

11. The non-transitory machine-readable medium of claim 10 comprises further executable instructions that, when executed by the at least one processor, cause the at least one processor to:
produce an array of asset classes;
map the array of asset classes to risk hedge positions; and
prepare and display a risk visualization.

12. The non-transitory machine-readable medium of claim 11 wherein the executable instructions cause the risk visualization to comprises a three-dimensional risk topology for a predetermined period of time.
